(19) United States
(12) Patent Application Publication
(10) Pub. No.: US 2012/0098156 A1
(43) Pub. Date: Apr. 26, 2012

(54) EXTRUSION DIE ELEMENT, EXTRUSION DIE AND METHOD FOR MAKING MULTIPLE STRIPE EXTRUDATE FROM MULTILAYER EXTRUDATE

(76) Inventors: Ronald W. Ausen, Saint Paul, MN (US); William J. Kopecky, Hudson, WI (US)

(21) Appl. No.: 13/376,514

(22) PCT Filed: Jun. 15, 2010
(86) PCT No.: PCT/US10/38680

§ 371 Date: Dec. 6, 2011

Related U.S. Application Data
(60) Provisional application No. 61/221,839, filed on Jun. 30, 2009.

(51) Int. Cl. B29C 47/06; B29C 47/30

(52) U.S. Cl. 264/171.1; 425/382.3

(57) ABSTRACT

An extrudate rotator die element, (24) extrusion die (18) comprising the extrudate rotator die element and a method for making multiple stripe extrudate from multilayer extrudate. The extrudate rotator die element (24) comprises a plurality of inlet slots (46), a plurality of outlet slots connected by rotated slot cavities (44). Each slot cavity (44) has a major cavity axis that rotates such that the outlet major axis of each outlet slot is oriented at an angle from the inlet major axis of the connected inlet slot (46) and the outlet slots are oriented such that each outlet major axis is coplanar with each other outlet major axis.

The present invention relates to the art of extruding materials, in particular, to extruding two or more phase-separated materials into a single article, and more particularly, to extruding multilayer extrudate into a multiple stripe extrudate.

### BACKGROUND

The extrusion of multiple polymeric materials into a single layer film is known in the art. For example, multiple polymeric flow streams have been combined in a die or feedblock in a layered fashion to provide a multilayer film having multiple layers stacked one on top of the other. It is also known to provide more complicated extruded film structures where the film is partitioned, not as a stack of layers in the thickness direction, but as stripes disposed side-by-side along the width dimension of the film. The known devices used to make such side-by-side striped films, however, have been unable to produce relatively inexpensive films with stripes having widths of 50 mils (1.27 mm) or less.

Accordingly, there is a need for further improvements in such devices for extruding multiple stripe films. The present invention provides such an improvement.

### SUMMARY OF THE INVENTION

In one aspect of the present invention, an extrudate rotator die element is provided for rotating the layer orientation of a multilayer extrudate such that the layers are reoriented from being stacked one on top of each other to being positioned side-by-side each other so as to form a multiple stripe extrudate. The extrudate rotator die element comprises a plurality of inlet slots, a plurality of outlet slots, and a plurality of rotated slot cavities. Each inlet slot is connected to one outlet slot through one slot cavity such that extrudate extruded into each inlet slot will come out one outlet slot through a connecting slot cavity. Each inlet slot can have, but does not need to have, an inlet major axis that is at least generally parallel to the inlet major axis of each other inlet slot. Each outlet slot has an outlet major axis that is coplanar with the outlet major axis of each other outlet slot. The outlet major axes are considered to be coplanar, according to the present invention, when the extrudate exiting from the outlet slots can be formed into a single extrudate such as, for example, in the form of a web, sheet, film or the like. Each slot cavity has a major cavity axis that rotates such that the outlet major axis of each outlet slot is oriented at an angle from the inlet major axis of the connected inlet slot and the outlet slots are oriented such that each outlet major axis is coplanar with each other outlet major axis.

The extrudate rotator die element can be provided in combination with an extrudate separator die element having a plurality of separator inlets, separator outlets and separator cavities. Each separator inlet is connected to one separator outlet through one separator cavity such that initial extrudate extruded into the separator inlets will come out the separator outlets in the form of a plurality of extrudate sections. Each separator inlet is operatively adapted (i.e., dimensioned and designed) for separating one extrudate section from the initial extrudate. Each connected separator cavity and separator outlet are operatively adapted (i.e., dimensioned and designed) to deliver one separated extrudate section to one inlet slot for extrusion through the corresponding slot cavity so as to result in a plurality of rotated extrudate sections at the outlet slots of the extrudate rotator die element.

In accordance with another aspect of the present invention, an extrusion die is provided that at least comprises the above described extrudate die element. It is desirable for the extrusion die to also comprise the above described extrudate separator die element. The extrusion die can also comprise at least one or both of an input land die element and an output land die element. The input land die element has an inlet for receiving the initial extrudate and an outlet operatively adapted (i.e., dimensioned and designed) for delivering the initial extrudate into the separator inlets of the extrudate separator die element. The output land die element is operatively adapted (i.e., dimensioned and designed) with an inlet for receiving the plurality of rotated extrudate sections from the outlet slots of the extrudate rotator die element and two opposing land surfaces. The two opposing land surfaces define a space therebetween for forming the plurality of rotated extrudate sections into a single extrudate (e.g., a multiple stripe extrudate).

In accordance with an additional aspect of the present invention, a method is provided for making a multiple stripe extrudate. The method comprises providing a multilayer extrudate having a plurality of layers stacked one on top of each other, separating the multilayer extrudate into a plurality of multilayer extrudate sections, forming the multilayer extrudate sections into a plurality of multiple stripe extrudate sections, and joining the plurality of multiple stripe extrudate sections together into a single multiple stripe extrudate. Each multilayer extrudate section has its layers stacked one on top of each other, and each layer of each multilayer extrudate section has opposite side edges. In addition, the multilayer extrudate sections are formed into a plurality of multiple stripe extrudate sections by rotating the layer orientation of each multilayer extrudate section from being stacked one on top of each other to being positioned side-by-side each other such that the opposite side edges of the layers of each multilayer extrudate section define opposite major surfaces of each corresponding multiple stripe extrudate section. Further, the plurality of multiple stripe extrudate sections are joined together into a single multiple stripe extrudate having opposite major surfaces defined by the opposite major surfaces of the plurality of multiple stripe extrudate sections.

This method can further comprise providing an extrudate separator die element as described above, with the separating step comprising extruding the multilayer extrudate into the plurality of separator inlets such that the multilayer extrudate comes out the separator outlets in the form of the plurality of multilayer extrudate sections. In addition, this method can further comprise providing an extrudate rotator die element as described above, with the forming step comprising extruding each of the plurality of multilayer extrudate sections into one of the inlet slots of the extrudate rotator die element, through the corresponding slot cavity and out the corresponding outlet slot. Furthermore, this method can also comprise providing an output land die element as described above, with the joining step comprising extruding the plurality of multiple stripe extrudate sections into the inlet of the output land die element and through the space between the two opposing land surfaces.

The above summary of the present invention is not intended to describe each disclosed embodiment or every implementation of the present invention. The description that follows more particularly exemplifies illustrative embodiments. It is to be understood, therefore, that the drawings and following description are for illustration purposes only and should not be read in a manner that would unduly limit the scope of this invention.

### BRIEF DESCRIPTION OF THE DRAWINGS

In the accompanying drawings:

FIG. 1 is an exploded perspective view of one embodiment of a set of extrusion die elements according to the present invention, including an upstream die element, an extrudate strip separator die element, an extrudate rotator die element, and a downstream land die element;

FIG. 2 is a cross-sectioned view of the extrudate strip separator die element of FIG. 1 taken along line 2-2;

FIG. 3 is a perspective view of one embodiment of an extrudate rotator die element comprising a stack of perforated plate-like shims according to the present invention, with only the first upstream shim, last downstream shim and a middle shim shown;

FIG. 4 is a cross-sectioned perspective view of a length of multilayer extrudate as it passes through the extrudate rotator die element of FIG. 3;

FIG. 5 is a cross-sectioned view of the output land die element of FIG. 1 taken along line 5-5;

FIG. 6 is a cross-sectioned end view of an extrusion die comprising the set of extrusion die elements of FIG. 1;

FIGS. 7A, 7B, 7C, 7D are diagrammatic perspective views of separate sections of a multilayer extrudate at the downstream end of each die elements in the set of die elements of FIG. 1; and

FIGS. 8A and 8B are cross-sectioned end views of two exemplary multiple stripe extrudate films according to the present invention with different width stripes formed at different angles.

### DETAILED DESCRIPTION OF PREFERRED EMBODIMENTS

In describing illustrative embodiments of the invention, specific terminology is used for the sake of clarity. The invention, however, is not intended to be limited to the specific terms so selected, and each term so selected includes all technical equivalents that operate similarly.

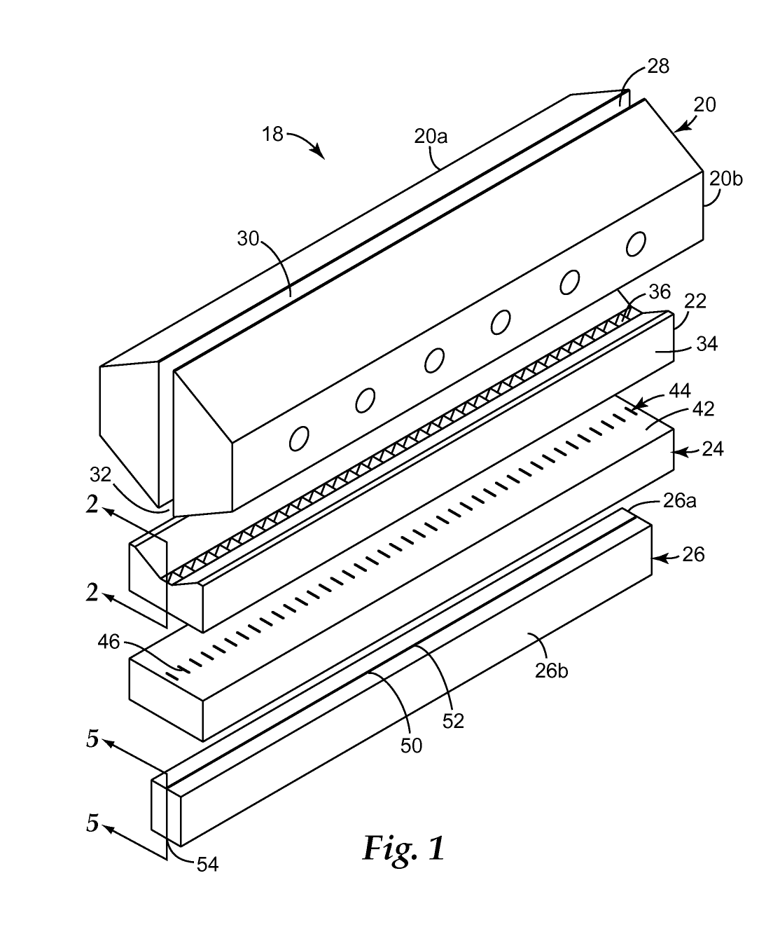

Referring to FIGS. 1 through 6, one embodiment of an extrusion die 18 according to the present invention can comprise an upstream or input land die element 20 (e.g., as a separate die insert), an extrudate strip separator die element (e.g., as a separate die insert or an integral die element), an extrudate rotator die element 24 (e.g., as a separate die insert), and a downstream or output land die element 26 (e.g., as a separate die insert). The input land die element 20 has a pair of opposing land surfaces 20a and 20b defining a space 28 therebetween with an inlet 30 and an outlet 32. The extrudate strip separator die element 22 has a body 34 with a plurality of separator inlets 36, with each separator inlet 36 being connected to one separator outlet 38 through a separator cavity 40. The extrudate rotator die element 24 includes a body 42 that can be in the form of a single piece monolith or a plurality of plates or shims. The body 42 has perforations that form a plurality of twisted or otherwise rotated slot cavities 44, with each rotated slot cavity 44 having an inlet slot 46 and an outlet slot 48. It is desirable, but not necessary, for the extrudate rotator die element 24 to comprise a plurality of plate-like or other shims that are stacked together and perforated so as to form the inlet slots 46, outlets slots 48 and slot cavities 44. Using a stack of relatively thin shims to form the extrudate rotator die element 24, rather than one large piece or only a few pieces, can enable the inlet slots 46, outlet slots 48 and slot cavities 24 to be formed less expensively and with greater dimensional precision. The output land die element 26 has two opposing land surfaces 26a and 26b defining a space 50 therebetween with an inlet 52 and an outlet 54.

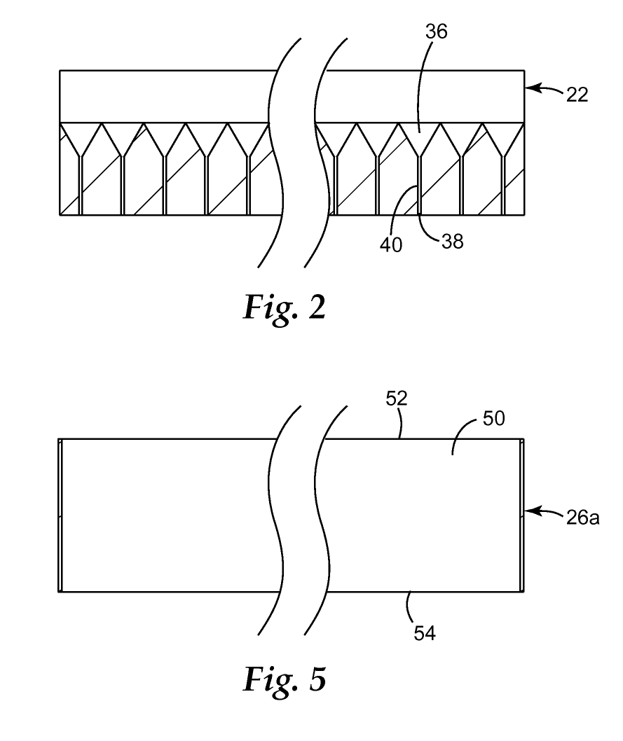

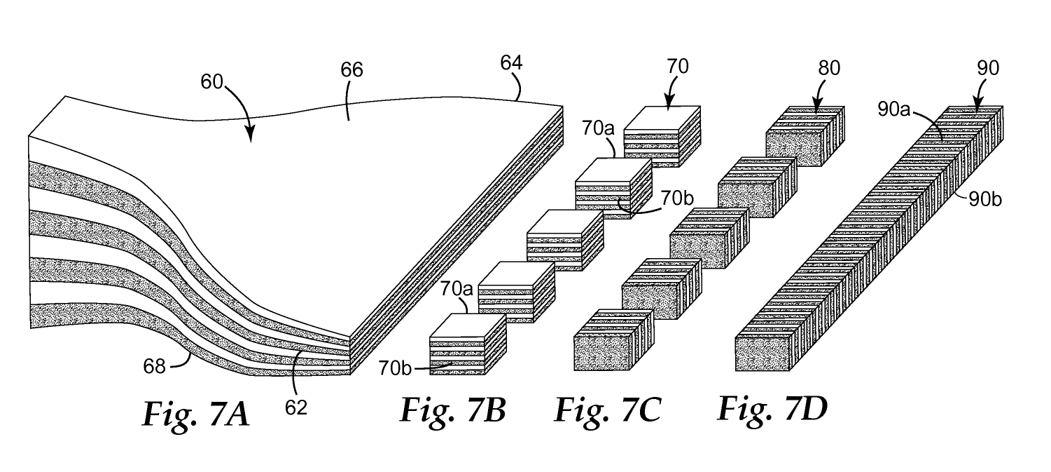

During the extrusion process, the inlet 30 of the input land die element 20 receives a multilayer extrudate 60, for example, in the form of a multiple layered structure of extrudable material (e.g., an adhesive, plastic or other polymeric material). Such a structure of extrudable polymeric layers may be created by using, for example, an apparatus like that found in U.S. Pat. No. 3,565,985, as well as U.S. Pat. No. 3,576,707, U.S. Pat. No. 3,647,612, U.S. Pat. No. 3,759,647, U.S. Pat. No. 5,223,276 or U.S. Pat. No. 6,626,206, which are incorporated herein by reference in their entirety. The multilayer extrudate 60 has a plurality of layers stacked one on top of each other so as to define opposite first and second side edges (or minor surfaces) 62 and 64 and opposite first and second major surfaces 66 and 68 (see FIG. 7A). The outlet of the input land die is operatively adapted (i.e., dimensioned and designed) for delivering the multilayer extrudate 60 into the separator inlets 36 of the extrudate strip separator die element 22. Referring to FIG. 2, each separator inlet 36 of the extrudate strip separator die element 22 is connected to one separator outlet 38 through one separator cavity 40 such that the multilayer extrudate 60 extruded into the separator inlets 36 will be divided so as to come out of the separator outlets 38 in the form of a corresponding plurality of multilayer extrudate strips or sections 70 (see FIG. 7B). To accomplish this, each separator inlet 36 is operatively adapted for cutting, slitting or otherwise separating one extrudate strip 70 from the multilayer extrudate 60. Each connected separator cavity 40 and separator outlet 38 are operatively adapted (i.e., dimensioned and designed) to deliver one separated extrudate strip 70 to one inlet slot 46 of the extrudate rotator die element 24 for extrusion therethrough.

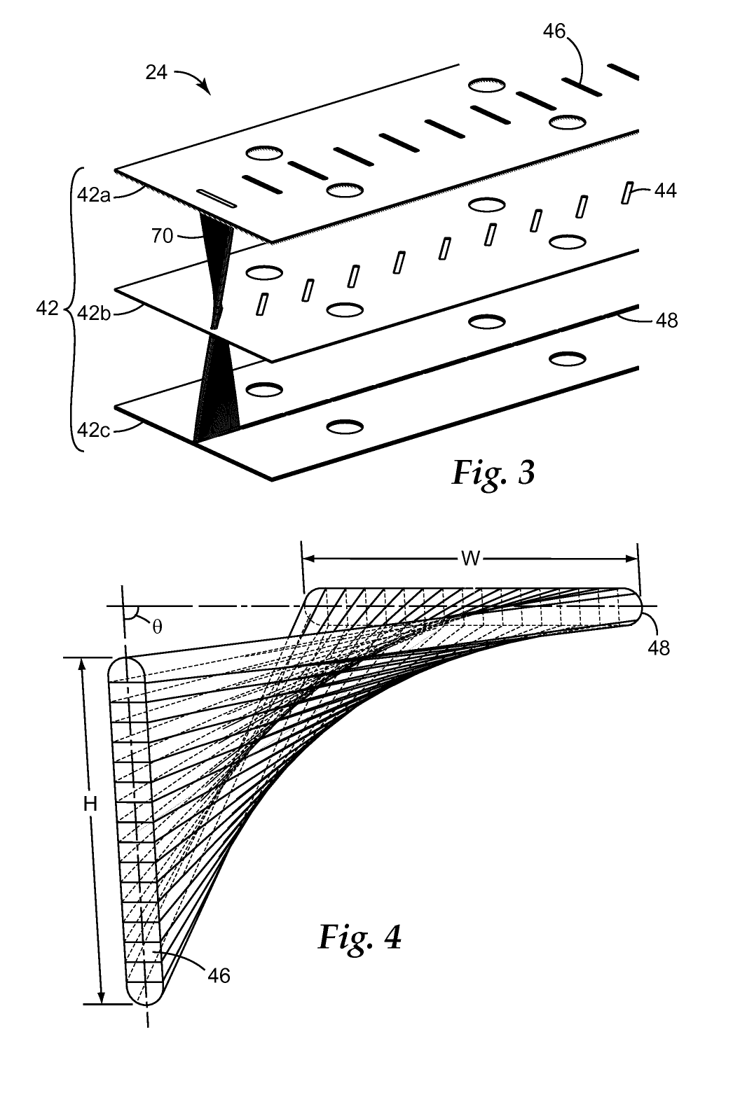

Referring to FIGS. 3 and 4, the body 42 of the illustrated extrudate rotator die element 24 is, preferably, in the form of a stack of perforated plate-like shims. Only three representative shims from such a stack are illustrated in FIG. 3. In particular, these three shims are the upstream shim 42a that forms the inlet slots 46 of body 42, the middle shim 42b in the middle of the stack, and the downstream shim 42c that forms the outlet slots 48. A twisted length of one exemplary multilayer extrudate strip 70 is illustrated to show the form of each rotated slot cavity 44. Each inlet slot 46 is connected to one outlet slot 48 through one slot cavity 44 such that the multilayer extrudate strip 70 (see FIG. 7B) extruded into each inlet slot 46 will come out one outlet slot 48 through a connecting slot cavity 44. As it is extruded through the corresponding slot cavity 44, the layer orientation of each multilayer extrudate section 70 is twisted or otherwise rotated such that, upon being extruded, the layers are reoriented from being stacked one on top of each other (see FIG. 7B) to being positioned side-by-side each other (see FIG. 7C). In this way, a multiple stripe extrudate section 80 (i.e., a rotated extrudate section 70) is formed at each outlet slot 48 of the extrudate rotator die element 24.

Referring to FIG. 4 and using the illustrated length of twisted extrudate strip 70 to depict the form of each rotated slot cavity 44, each inlet slot 46 of the die element 24 has an inlet diameter or thickness and an inlet major axis or height H. It can be desirable for the inlet major axis of each inlet slot 46 to be at least generally parallel to the inlet major axis of each other inlet slot 46. Each outlet slot 48 has an outlet diameter or thickness and an outlet major axis or width W that is at least substantially coplanar with the outlet major axis of each other outlet slot 48. The outlet major axes are considered to be sufficiently coplanar, according to the present invention, when the multiple stripe extrudate sections 80 exiting from the outlet slots 48 can be formed into a single multiple stripe extrudate 90 such as, for example, in the form of a web, sheet, film or the like. As used herein, the terms film, web, sheet and the like are interchangeable. In addition, each slot cavity 44 has a cavity diameter or thickness and a major cavity axis that twists or otherwise rotates as the slot cavity 44 passes through the body 42 of the extrudate rotator die element 24. Each slot cavity 44 rotates such that the outlet major axis of each connected outlet slot 48 is oriented at an angle θ from its corresponding inlet major axis, where the angle θ is sufficiently large to cause rotation of the multilayer extrudate strip sections 70 such that the layers of each strip section 70 become oriented side-by-side each other (see multiple stripe extrudate sections 80). It can be desirable for each inlet slot 46, each outlet slot 48 and each slot cavity 44 to have the same diameter or thickness within acceptable tolerances. It may also be desirable, for example, for each outlet slot 48 to have a diameter or thickness that is less than that of the corresponding inlet slot 46.

Each inlet slot 46, each outlet slot 48 and each slot cavity 44 can have a diameter or thickness in the range of from about 10 mils (254 microns) to about 50 mils (1270 microns). Each inlet slot 46, each outlet slot 48 and each slot cavity 44 can also have a diameter or thickness in the range of from about 10 mils (254 microns) to about 40 mils (1016 microns) or even in the range of from about 10 mils (254 microns) to about 20 mils (508 microns). In addition, each inlet slot 46, each outlet slot 48 and each slot cavity 44 can have a major axis length in the range of from about 50 mils (1.27 mm) to about 500 mils (12.7 mm). Each inlet slot 46, each outlet slot 48 and each slot cavity 44 can also have a major axis length in the range of from about 100 mils (2.54 mm) to about 250 mils (6.35 mm). Furthermore, it is desirable for the angle θ between each outlet major axis and its corresponding inlet major axis to be greater than about 10 degrees. For example, this angle θ can be in the range of from about 10° to about 150°. This angle θ can also be in the range of from about 85° to about 125°.

Referring to FIG. 5, the inlet 52 of the output land die element 26 is operatively adapted (i.e., dimensioned and designed) for receiving the plurality of multiple stripe extrudate sections 80 (see FIG. 7C) from the outlet slots 48 of the extrudate rotator die element 24, and the space 50 between the two opposing land surfaces 26a and 26b is operatively adapted (i.e., dimensioned and designed) for joining or otherwise forming the plurality of multiple stripe extrudate sections 80 into the single multiple stripe extrudate 90 (see FIG. 7D).

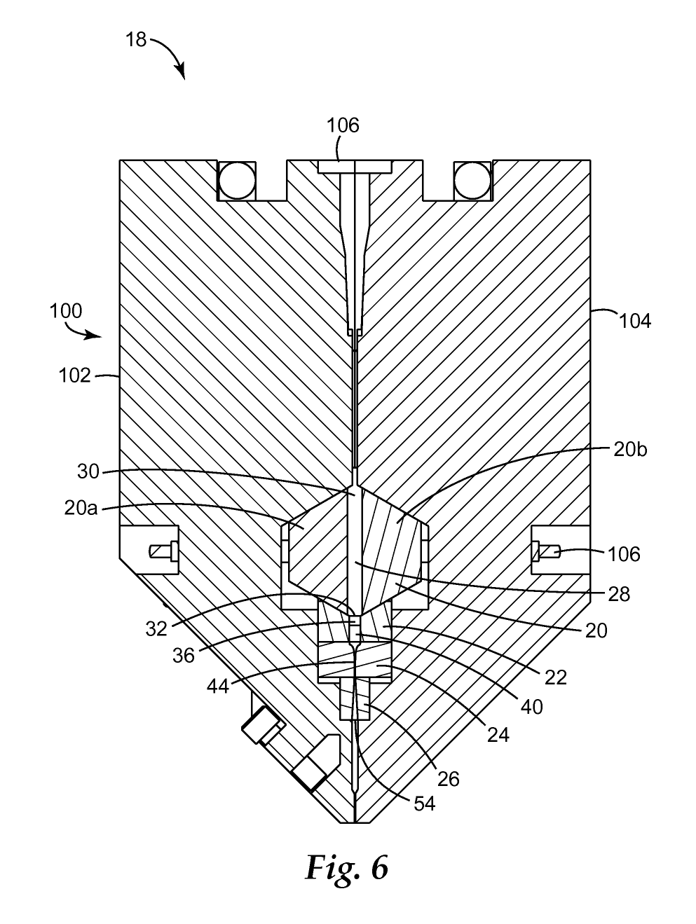

Referring to FIG. 6, an exemplary extrusion die 18 is depicted assembled, including elements discussed above in their proper order. A die body 100 including a first half 102 and a second half 104 can be assembled using bolts 106 or the like. The multilayer extrudate 60 enters at the die body inlet 106, typically from a feedblock of conventional type. The multilayer extrudate 60 is moved toward the input land die element 20, through space 28 and through extrudate strip separator 22 where the multilayer extrudate 60 is divided into multilayer extrudate strip sections 70. Sections 70 then enter extrudate rotator die element 24, which rotates the multilayer extrudate strip sections 70 into multiple stripe extrudate sections 80. Sections 80 are then consolidated into the single multiple stripe extrudate 90 as the sections 80 pass through and exit output land die element 26.

Referring to FIGS. 7A-7D, with the above described set of die elements, a multilayer extrudate 60 (see FIG. 7A) that is extruded through the extrudate strip separator 22 will be extruded into the separator inlets 36 and thereby separated into a plurality of multilayer extrudate strip sections 70 (see FIG. 7B). Each layer of each extrudate strip section 70 will have opposite side edges 70a and 70b. Each extrudate strip section 70 will twist or otherwise rotate as the extrudate strip section 70 passes (i.e., is extruded) through the corresponding slot cavity 44 of the extrudate rotator die element 24 such that the extrudate strip section 70 exits the corresponding outlet slot 48 with its layers oriented side-by-side each other rather than their previous orientation of one on top of each other (see FIG. 7C). The resulting multiple stripe extrudate sections 80 are then extruded through the output land die element 26 and, thereby, joined into a single multiple stripe extrudate 90 (see FIG. 7D). As used herein, the term “side-by-side” refers to the layers of each multilayer extrudate section 70 being rotated so that the opposite side edges 70a and 70b of the plurality of multilayer extrudate sections 70 form the opposite major surfaces 90a and 90b of the resulting single multiple stripe extrudate 90.

The multilayer extrudate 60 can be wider than it is thick, has opposite side edges (or minor surfaces) 62 and 64 and opposite major surfaces 66 and 68, and comprises two or more layers (e.g., at least 3, 4, 5, 10, 20, 30, 40, 50, 60, 70, 80, 90, 100, 150, 200, 250, 300, 350, 400, 450, 500, 550, 600, or more layers) stacked one on top of each other. Each layer of the multilayer extrudate 60 likewise has opposite side edges (or minor surfaces) and opposite major surfaces. As used herein, the phrase “stacked one on top of each other” refers to each extrudate layer having at least one of its two opposite major surfaces facing, and preferably contacting, a major surface of an adjacent extrudate layer such that the side edges of the extrudate layers define the opposite side edges of the multilayer extrudate 60. If desired or necessary (e.g., to prevent layer delamination), there may be an intermediate layer such as, for example, a tie or primer layer located between one or more or each pair of adjacent extrudate layers. Both or only one of the two opposite major surfaces of the multilayer extrudate can be formed by a skin layer.

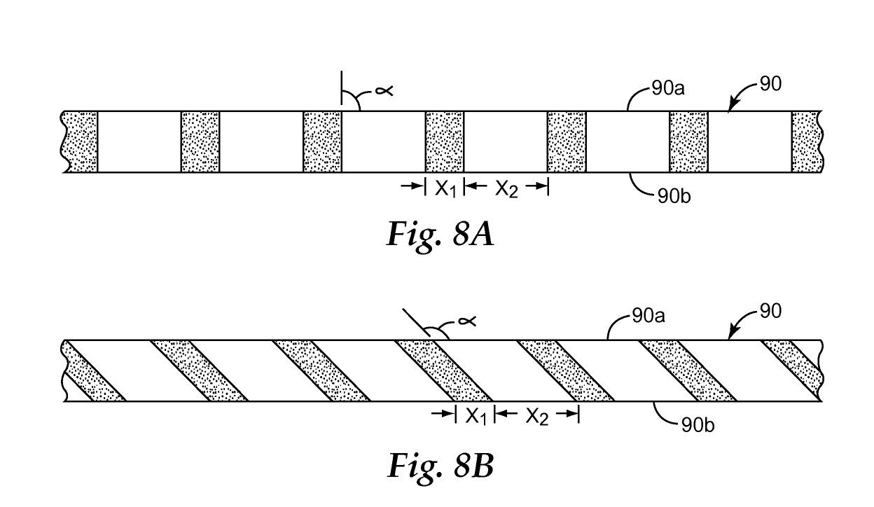

Referring to FIGS. 8A and 8B, the side-by-side stripes of the resulting multiple stripe extrudate 90 can have the same or varying widths, e.g., width x₁, width x₂, etc. Stripes with varying widths can be produced by using a multilayer extrudate 60 having layers with varying thicknesses. It can be also be desirable for the stripes to be made from any number of different extrudate materials. For example, one material (e.g., an adhesive) can be used for every odd numbered stripe (i.e., every other layer in the multilayer extrudate 60) and another material (e.g., a plastic) can be used for every even numbered stripe (i.e., each remaining layer in the multilayer extrudate 60). In addition, each of three or more extrudable materials can be used to form the layers of the multilayer extrudate 60 and thereby the stripes of a corresponding multiple stripe extrudate 90. Each stripe formed from a different extrudate material can also be made so as to have a different width. Because the stripes in the multiple stripe extrudate 90 are formed from the layers of the original multilayer extrudate 60, the width of the stripes depends on the thickness of the layers in the original multilayer extrudate 60. Therefore, because relatively thin films (e.g., ranging in thickness from 1 mil to 10 mils (25.4 microns to 254 microns) or greater can be extruded with up to hundreds of layers, the stripes can now be made much smaller in width than was previously possible. For example, stripes with widths in the range of from about 25 microns up to about 50 microns are now possible. Furthermore, the interface between adjoining stripes in the multiple stripe extrudate can be oriented relative to the major surfaces of the multiple stripe extrudate at any angle α considered desirable. It can be desirable for the angle α to be within the range of from about 20 degrees to about 90 degrees. It may also be acceptable for the angle α to be an acute or obtuse angle. Whatever the angle α, it is desirable for most (i.e., more than 50%, 60%, 70%, 80%, 90%), and preferably each, of the side edges of the layers forming the multilayer extrudate sections 70 to be used in forming the two major surfaces of the multiple stripe extrudate 90. It is understood that the present invention is not intended to be limited to any particular configuration of, or materials used to make, the multiple strip extrudate. The above described configurations and materials are for example only.

A multiple stripe extrudate film, web, sheet, etc. can be made from a multilayer extrudate according to a method that comprises providing a multilayer extrudate, separating the multilayer extrudate into a plurality of multilayer extrudate sections, forming the multilayer extrudate sections into a plurality of multiple stripe extrudate sections, and joining the plurality of multiple stripe extrudate sections together into a single multiple stripe extrudate. In one embodiment of the present method, the multilayer extrudate being provided is a multilayer web, sheet, film, etc. of extrudable polymeric material (e.g., an adhesive and/or plastic) having a plurality of layers stacked one on top of each other so as to define opposite first and second side edges (or minor surfaces) and opposite first and second major surfaces. The multilayer extrudate is separated into a plurality of multilayer extrudate strips by any suitable means such as, for example, that disclosed above as well as using conventional cutting or slitting tools. Each resulting multilayer extrudate strip has its layers stacked one on top of each other, with each layer of each multilayer extrudate strip having opposite first and second side edges. The multilayer extrudate strips are formed into a plurality of multiple stripe extrudate strips by twisting each multilayer extrudate strip so that its layer orientation changes from being stacked one on top of each other to being positioned side-by-side each other. In this way, the opposite side edges of the layers of each multilayer extrudate strip will define opposite major surfaces of each corresponding multiple stripe extrudate strip. The plurality of multiple stripe extrudate strips are joined together into a single multiple stripe extrudate film, web, or sheet by extruding the multiple stripe extrudate strips together between opposing land surfaces, before being extruded out of the extrusion die. The resulting single multiple stripe extrudate will have opposite major surfaces defined by the opposite major surfaces of the plurality of multiple stripe extrudate strips.

### Example 1

In the following example of a method for making a microstriped film, a conventional multilayer feedblock, like that shown in U.S. Pat. No. 3,565,985, was first used to create a multiple layer extrudate of 13 alternating layers of polymer A and polymer B. Polymers A and B were each a polypropylene homopolymer, commercially available as PP 1024E4 from Exxon Mobil of Houston, Tex. To differentiate the two polymers, approximately 2% by weight of a commercially available blue pigment was added to Polymer A. The Polymer A mixture was fed using a conventional 25 mm twin screw extruder. Polymer B was fed using a conventional 1.25 inch, (32 mm) single screw extruder. A gear pump was used to feed each polymer from their respective extruder to the multilayer feedblock. The resulting multilayer feedstream or extrudate was then fed directly into a conventional skin layer feedblock whereby a top skin was added above and a bottom skin was added underneath the 13 layer extrudate to form a resulting multilayer extrudate structure having a total of 15 layers. The first skin layer was composed of Polymer B. The first skin layer material was fed with a Killion 1.25 inch (32 mm) single screw extruder, commercially available from Davis-Standard of Pawcatuck, Conn. The second skin layer was also composed of Polymer B. The second skin layer material was fed with a Killion 0.75 inch (19 mm) single screw extruder also commercially available from Davis-Standard of Pawcatuck, Conn.

The following temperatures and extruder RPMs were used:

TABLE 1

| | Polymer A | Polymer B | Skin | Skin |
|---|---|---|---|---|
| | Extruder | Extruder | Extruder 1 | Extruder 2 |
| Barrel zone 1 | 300 | 300 | 300 | 300 |
| ° F. | | | | |
| Subsequent | 410 | 410 | 410 | 410 |
| Barrel zones ° F. | | | | |
| Necktube ° F. | 410 | 410 | 410 | 410 |
| lbs/hr delivered | 5 | 10 | 4 | 4 |

The extruders fed the multilayer feedblock, which was itself set to 410° F. From the feedblock, the resulting 15 layer extrudate was fed into a conventional 20 cm coathanger die, which was adapted to include die elements 24 and 26 according to the present invention and generally as depicted in FIG. 6. The inlet slots 46 on the extrudate rotator die element 24 were spaced 0.200 inches (5.08 mm) apart, and were 0.20 inches (0.5 mm) tall and 0.02 inches (0.5 mm) in width. Each slot cavity 44 rotated 90 degrees as it progressed from the inlet slot 46 through the body 42 and to the outlet slot 48. Each outlet slot 48 was dimensioned the same as its corresponding inlet slot 46. The inlet 52 of the output land die element 26 was a slot having a diameter of 0.02 inch (0.5 mm) and a width of 8.0 inches (20 cm). The outlet 54 of the output land die element 26 was a slot having a diameter of 0.015 inch (0.38 mm) and a width of 8.0 inches (20 cm). The outlet 54 formed the outlet for the die. A multiple stripe extrudate film resulted that was cast onto a chrome roll chilled at a temperature of 70° F. The takeaway speed of the extrudate film from the die was 13 ft/min (3.96 m/min).

### Examples 2-6

In these examples, the same equipment was used as that in Example 1. The two extruders were also used to feed two polymers into the multilayer feedblock. The multilayer feedblock produced a stack of 13 alternating layers of polymer A and polymer B. No skin layers were used. This 13 layer stack was then fed into the same 20 cm wide coat-hanger extrusion die construction as was used in Example 1, except that a different rotator die element 24 was used, as described below. The inlet slots were spaced 0.200 inches (5.08 mm) apart. Dimensions of the slots were as described in Table 2 below. Each slot rotated 90 degrees as it progressed through the rotator die element. Using this die arrangement, side-by-side multistriped film was cast onto a smooth chill roll where it was quenched. The resulting film was then wound up to form a finished roll.

The films of Examples 2-6 were produced as follows and per Table 2 below.

### Example 2

The inlet and outlet slots of the rotator die element had a height/width of 190 mils and a diameter/thickness of 40 mils. The slots were separated 200 mils on center. The 40 mil dimension resulted in less rotation of the layers.

### Example 3

The inlet and outlet slots of the rotator die element had a height/width of 190 mils and a diameter/thickness of 20 mils. The slots were separated 200 mils on center. The rotation of the layers was better than that of Example 2.

### Example 4

The inlet and outlet slots of the rotator die element had a height/width of 190 mils and a diameter/thickness of 15 mils. The slots were separated 200 mils on center. This example, with the narrower 15 mil dimension, provided the best uniformity and rotation of the layers.

### Example 5

The rotator die element had a 190 mil×20 mil inlet slot and a 100 mil×20 mil exit slot. The slots were separated 200 mils on center. This example produced good multiple striped film and demonstrates that the inlet and the outlet slots need not have identical height and width dimensions.

### Example 6

The rotator die element had a 100 mil×20 mil slot. The slots were separated 200 mils on center. The run produced a film similar to that of Example 3.

TABLE 2

| | Example 2 | Example 3 | Example 4 | Example 5 | Example 6 |
|---|---|---|---|---|---|
| Extruder A | 25 mm twin | 25 mm twin | 25 mm twin | 25 mm twin | 25 mm twin |
| | Screw | Screw | Screw | Screw | Screw |
| | extruder | extruder | extruder | extruder | extruder |
| Polymer A | Polypropylene | Polypropylene | Polypropyleen | Polypropylene | Polypropylene |
| | 1024 | 1024 | 6253 | 6253 | 6253 |
| Extruder A | 215° C. | 215° C. | 220° C. | 220° C. | 220° C. |
| Barrel 1 | | | | | |
| Extruder A | 215° C. | 215° C. | 220° C. | 220° C. | 220° C. |
| Remaining | | | | | |
| Barrel Temps | | | | | |
| Polymer A lb/hr | 7.5 | 7.5 | 5 | 5 | 5 |
| Extruder B | 18 mm twin | 18 mm twin | 1.25 inch | 1.25 inch | 1.25 inch |
| | screw | screw | single screw | single screw | single screw |
| | extruder | extruder | extruder | extruder | extruder |
| Polymer B | Polypropylene | Polypropylene | Polypropylene | Polypropylene | Polypropylene |
| | 1024 with | 1024 with | 6253 with | 6253 with | 6253 with |
| | 2% black | 2% black | 2% black | 2% black | 2% black |
| | color conc | color conc | color conc | color conc | color conc |
| Extruder B | 215° C. | 215° C. | 190° C. | 190° C. | 190° C. |
| Barrel 1 Temp | | | | | |
| Extruder B | 215° C. | 215° C. | 220° C. | 220° C. | 220° C. |
| Remaining | | | | | |
| Barrel Temps | | | | | |
| Polymer B lb/hr | 7.5 | 7.5 | 5 | 5 | 5 |
| Feedblock # | 29 | 29 | 29 | 29 | 29 |
| layers | | | | | |
| Feedblock Temp | 215° C. | 215° C. | 220° C. | 220° C. | 220° C. |
| Die Temp | 215° C. | 215° C. | 220° C. | 220° C. | 220° C. |
| Quench roll temp | 50° F. | 50° F. | 25° C. | 25° C. | 25° C. |
| Linespeed ft/min | 20 | 20 | 5 | 5 | 10 |

### Example 7

The film of Example 7 was produced as follows: In the following example of a method for making a microstriped film, a conventional multilayer feedblock, like that shown in U.S. Pat. No. 3,565,985, was used to feed a die generally as described in FIG. 6. The input land die element had a space of 190 mils. It was adjacent an extrudate strip separator die element having a plurality of separator inlets spaced every 200 mils on center. The separator inlets narrowed from 200 mils wide on the upstream side and down to 15 mils wide at downstream side.

The downstream exits of the extrudate strip separator die element fed into the rotator die element, which had inlet and outlet slots having a height/width of 190 mils and a diameter/thickness of 15 mils. The slots were separated 200 mils on center at their inlets. The slots in the rotator die element twisted through an angle of 90 degrees. Two extruders were also used to feed two polymers into the multilayer feedblock described for Examples 1-6. Once again, the multilayer feedblock produced a stack of 13 alternating layers of Polymer A and polymer B. No skin layers were used. In this example, Polymer A was a pressure sensitive acrylate copolymer adhesive, 95:5 ethyl hexyl acrylate:acrylic acid. Polymer B was polyethylene polymer commercially available as Engage™ 8200 from Dow Chemical. To differentiate the two polymers, approximately 2% by weight of a commercially available black pigment was added to Polymer B. Both Polymers A and B were fed using a conventional 1.25 inch, (32 mm) single screw extruders. Polymer A was extruded at a rate of 5.8 pounds/hr at a barrel temperature of 325° F., while Polymer B was extruded at a rate of 1.8 pounds/hr at a barrel temperature of 350° F. The die was operated at a temperature of 400° F. A multiple stripe extrudate film resulted that was cast onto a chrome roll chilled at a temperature of 70° F. The takeaway speed of the extrudate film from the die was 10 ft/min (3.05 m/min). The final film showed well shaped, regular stripes, and demonstrated that the method can be used to make film having adhesive qualities.

This invention may take on various modifications and alterations without departing from its spirit and scope. Accordingly, this invention is not limited to the above-described embodiments but is to be controlled by the limitations set forth in the following claims and any equivalents thereof. This invention may be suitably practiced in the absence of any element not specifically disclosed herein. All patents and patent applications cited above, including those in the Background section, are hereby incorporated by reference into this document in their entirety.

1. An extrudate rotator die element for rotating the layer orientation of a multilayer extrudate such that the layers are reoriented from being stacked one on top of each other to being positioned side-by-side each other so as to form a multiple stripe extrudate, said extrudate rotator die element comprising:
a plurality of inlet slots, a plurality of outlet slots, and a plurality of rotated slot cavities, with each inlet slot being connected to one outlet slot through one slot cavity such that extrudate extruded into each inlet slot will come out one outlet slot through a connecting slot cavity, each inlet slot having an inlet major axis, each outlet slot having an outlet major axis, and each slot cavity having a major cavity axis that rotates such that the outlet major axis of each outlet slot is oriented at an angle from the inlet major axis of the connected inlet slot and the outlet slots are oriented such that each outlet major axis is coplanar with each other outlet major axis.

2. The extrudate rotator die element according to claim 1, wherein said extrudate rotator die element comprises a plurality of shims that are stacked together and perforated so as to form the inlet slots, outlets slots and slot cavities.

3. The extrudate rotator die element according to claim 1, wherein the major axes of the inlet slots are parallel to each other.

4. The extrudate rotator die element according to claim 1, wherein each inlet slot, each outlet slot and each slot cavity has the same thickness.

5. The extrudate rotator die element according to claim 1, wherein each inlet slot, each outlet slot and each slot cavity has a thickness in the range of from about 10 mils (254 microns) to about 50 mils (1270 microns).

6. The extrudate rotator die element according to claim 1, wherein each inlet slot, each outlet slot and each slot cavity has a major axis length in the range of from about 50 mils (1.27 mm) to about 500 mils (12.7 mm).

7. The extrudate rotator die element according to claim 1, wherein each outlet major axis is at an angle from each inlet major axis in the range of from about 45° to about 135°.

8. The extrudate rotator die element according to claim 1 in combination with an extrudate separator die element having a plurality of separator inlets, separator outlets and separator cavities, with each separator inlet being connected to one separator outlet through one separator cavity such that initial extrudate extruded into the separator inlets will come out the separator outlets in the form of a plurality of extrudate sections, wherein each separator inlet is operatively adapted for separating one extrudate section from the initial extrudate, and each connected separator cavity and separator outlet are operatively adapted to deliver one separated extrudate section to one inlet slot for extrusion through the corresponding slot cavity so as to result in a plurality of rotated extrudate sections at the outlet slots of said extrudate rotator die element.

9. An extrusion die comprising an extrudate rotator die element according to claim 1.

10. An extrusion die comprising an extrudate rotator die element and extrudate separator die element according to claim 9.

11. The extrusion die according to claim 10 further comprising at least one of an input land die element and an output land die element, wherein said input land die element has an inlet for receiving the initial extrudate and an outlet operatively adapted for delivering the initial extrudate into the separator inlets of said extrudate separator die element, and said output land die element is operatively adapted with an inlet for receiving the plurality of rotated extrudate sections from the outlet slots of said extrudate rotator die element and two opposing land surfaces defining a space therebetween for forming the plurality of rotated extrudate sections into a single extrudate.

12. A method of making a multiple stripe extrudate, said method comprising:
providing a multilayer extrudate having a plurality of layers stacked one on top of each other;
separating the multilayer extrudate into a plurality of multilayer extrudate sections, with each multilayer extrudate section having its layers stacked one on top of each other, and each layer of each multilayer extrudate section having opposite side edges;
forming the multilayer extrudate sections into a plurality of multiple stripe extrudate sections by rotating the layer orientation of each multilayer extrudate section from being stacked one on top of each other to being positioned side-by-side each other such that the opposite side edges of the layers of each multilayer extrudate section define opposite major surfaces of each corresponding multiple stripe extrudate section;
joining the plurality of multiple stripe extrudate sections together into a single multiple stripe extrudate having opposite major surfaces defined by the opposite major surfaces of the plurality of multiple stripe extrudate sections; and
providing an extrudate separator die element having a plurality of separator inlets, separator outlets and separator cavities, with each separator inlet being connected to one separator outlet through one separator cavity such that extrudate extruded into the separator inlets will come out the separator outlets in the form of a plurality of separate extrudate sections,
wherein said separating comprises extruding the multilayer extrudate into the plurality of separator inlets such that the multilayer extrudate comes out the separator outlets in the form of the plurality of multilayer extrudate sections.

13. (canceled)

14. The method according to claim 12 further comprising:
providing an extrudate rotator die element having a plurality of inlet slots, a plurality of outlet slots, and a plurality of rotated slot cavities, with each inlet slot being connected to one outlet slot through one slot cavity such that extrudate extruded into each inlet slot will come out one outlet slot through a connecting slot cavity, each inlet slot having an inlet major axis, each outlet slot having an outlet major axis, and each slot cavity having a major cavity axis that rotates such that the outlet major axis of each outlet slot is oriented at an angle from the inlet major axis of the connected inlet slot and the outlet slots are oriented such that each outlet major axis is coplanar with each other outlet major axis,
wherein said forming comprises extruding each of the plurality of multilayer extrudate sections into one of the inlet slots of the extrudate rotator die element, through the corresponding slot cavity and out the corresponding outlet slot.

15. The method according to claim 14 further comprising:
providing an output land die element having an inlet for receiving the plurality of multiple stripe extrudate sections from the outlet slots of the extrudate rotator die element and two opposing land surfaces defining a space therebetween for forming the plurality of multiple stripe extrudate sections into a single multiple stripe extrudate,
wherein said joining comprises extruding the plurality of multiple stripe extrudate sections into the inlet of the output land die element and through the space between the two opposing land surfaces.
